(19) United States
(12) Patent Application Publication
(10) Pub. No.: US 2015/0084217 A1
(43) Pub. Date: Mar. 26, 2015

(54) MICRO-FEATURE METHODS FOR OVER-MOLDING SUBSTRATE

(71) Applicant: Corning Incorporated, Corning, NY (US)

(72) Inventors: John Claude Cadotte, JR., Waterboro, ME (US); Christopher Lee Timmons, Big Flats, NY (US); Tyler Wezner, Riverside, RI (US)

(73) Assignee: Corning Incorporated, Corning, NY (US)

(21) Appl. No.: 14/386,193

(22) PCT Filed: Mar. 26, 2013
(86) PCT No.: PCT/US13/33803

§ 371 Date: Sep. 18, 2014

Related U.S. Application Data
(60) Provisional application No. 61/616,085, filed on Mar. 27, 2012.

(51) Int. Cl. B29D 11/00; B29C 45/16

(52) U.S. Cl. CPC B29D 11/00769; B29C 45/16
USPC 264/1.24

(57) ABSTRACT

A method of making a microplate, including: injection molding a resin to form a substrate (900) having a grating region feature on a surface of the substrate, and at least one micro-feature (910) in the vicinity of the grating region feature; waveguide treating (920) the resulting molded substrate; and over-molding the resulting waveguide treated molded substrate with a compatible resin to from the integral well plate (935) on the microplate. Also disclosed is a method of making a microplate, including: surface roughening to form a bonding area on a waveguide coated surface of a polymeric substrate having an integral grating region; and over-molding the resulting surface roughened substrate and a compatible resin to form the integral microplate, as defined herein.

### CROSS-REFERENCE TO RELATED APPLICATIONS

This application claims the benefit of priority under 35 U.S.C. §119 of U.S. Provisional Application Ser. No. 61/616,085, filed Mar. 27, 2012, the content of which is relied upon and incorporated herein by reference in its entirety.

This application is related to commonly owned and assigned U.S. Provisional Patent Application Ser. No. 61/616,089, entitled “Low Birefringent Sensor Substrate and Methods Thereof,” filed on Mar. 27, 2012, concurrently herewith but does not claim priority thereto.

### FIELD

The disclosure relates generally to methods for making microplates having grating sensors.

### BACKGROUND

Various methods are known for making microplates having grating sensors.

### SUMMARY

The disclosure provides a method of making a microplate that includes a sensor-substrate having an integral well plate.

### BRIEF DESCRIPTION OF THE FIGURES

In embodiments of the disclosure:

FIG. 1 shows a prior art method for assembly of an EPIC® microplate.

FIG. 2 shows the bonding region(s) on a substrate as thick circular lines around six wells in a corner of a substrate.

FIG. 3 shows a comparative flow chart of the prior art process (left side) of making the microplate shown in FIG. 1 and the disclosed over-molding process (right side).

FIG. 4 shows a typical Zygo RMS imagery and quantitative output from optical profilometry of an exemplary roughened substrate.

FIG. 5 shows an SEM cross-section of mechanically roughened substrate (bottom) bonded to an over-molded well plate (top).

FIG. 6 shows a flow chart of the substrate stamper replication process and suggests that surface roughening can be conveniently and optionally accomplished at one or more steps in the substrate molding process.

FIG. 7 shows a schematic of representative microplate in plan view where the shaded ovals indicate areas where leaky well regions were typically or consistently obtained for microplates made by many of the less useful patterning methods.

FIGS. 8A and 8B show, respectively, exemplary optical micrographs of before over-molding (left image; 8A) and after over-molding (right image; 8B) substrates having the five raised concentric ring pattern produced by laser cutting the molding master.

FIGS. 9A and 9B show, respectively, before and after over-molding schematics that illustrate a hypothetical mechanism for the chemical bonding expected in disclosed Method 3.

FIG. 10 shows an optical micrograph of a substrate having features that were over-molded using Method 3.

### DETAILED DESCRIPTION

Various embodiments of the disclosure will be described in detail with reference to drawings, if any. Reference to various embodiments does not limit the scope of the invention, which is limited only by the scope of the claims. Additionally, any examples set forth in this specification are not limiting and merely set forth some of the many possible embodiments of the claimed invention.

In embodiments, the disclosed articles, and the method of making and use of the articles provide one or more advantageous features or aspects including, for example, as discussed below. Features or aspects recited in any of the claims are generally applicable to all facets of the invention. Any recited single or multiple feature or aspect in any one claim can generally be combined or permuted with any other recited feature or aspect in any other claim or claims.

### DEFINITIONS

“Integral” in the context of the “integral grating region” refers to an integrated or single piece construction arising from the single injection step used to mold the article that simultaneously, or at the same time, produces the polymeric substrate having the at least one integral grating region.

“Integral” in the context of the “integral well plate bonded to the article” refers to an integrated or single piece construction arising from joining the molded article comprising the combined substrate and grating region with a well plate structure. The joining of the article and the well plate can be accomplished, for example, in an over-mold step, or like methods.

“Micro-featuring,” “micro-feature,” “micro-texturing,” “micro-texture,” “micro-patterning,” “micro-pattern,” “micro-structuring,” “micro-structure,” and like terms refer to a structure integral to the substrate which can extend away from, protrude from, extend into, or protrude into (such as pits, grooves, dimples, or depressions) the plane surface of the substrate, for example, features, textures, patterns, or like micro-structures, that are designed into the micro-feature generating relief stamper or embosser.

“Collapsible feature,” “collapsible featuring,” “collapsed feature(s),” and like terms refer to an integral structure which can extend away from, or protrude from the plane surface of the substrate. The collapsible feature can have fugitive qualities or properties, such as under going, for example, shape or size deformation, decay, melt, erosion, disintegration, or like morphological phenomena, when the collapsible feature is contacted by the flowing hot melt.

“Include,” “includes,” or like terms means encompassing but not limited to, that is, inclusive and not exclusive.

“About” modifying, for example, the quantity of an ingredient in a composition, concentrations, volumes, process temperature, process time, yields, flow rates, pressures, and like values, and ranges thereof, employed in describing the embodiments of the disclosure, refers to variation in the numerical quantity that can occur, for example: through typical measuring and handling procedures used for making compositions, concentrates, or use formulations; through inadvertent error in these procedures; through differences in the manufacture, source, or purity of starting materials or ingredients used to carry out the methods; and like considerations. The term “about” also encompasses amounts that differ due to aging of a composition or formulation with a particular initial concentration or mixture, and amounts that differ due to mixing or processing a composition or formulation with a particular initial concentration or mixture. The appended claims include equivalents of these “about” quantities.

“Consisting essentially of” in embodiments refers, for example, to a sensor-substrate article or a well plate article having, for example, predetermined physical properties such as birefringence, to a method of making a sensor-substrate article or a well plate article, and can include the components or steps listed in the claim, plus other components or steps that do not materially affect the basic and novel properties of the compositions, articles, apparatus, or methods of making and use of the disclosure, such as particular reactants, particular additives or ingredients, a particular agents, a particular surface modifier or condition, or like structure, material, or process variable selected. Items that may materially affect the basic properties of the components or steps of the disclosure or that may impart undesirable characteristics to the present disclosure include, for example, a method of making having one or more additional unit operations or manufacturing steps, or an article having a significantly higher cost or significantly higher manufacturing complexity contributing to a higher unit cost, as defined and specified herein.

The indefinite article “a” or “an” and its corresponding definite article “the” as used herein means at least one, or one or more, unless specified otherwise.

Abbreviations, which are well known to one of ordinary skill in the art, may be used (e.g., “h” or “hr” for hour or hours, “g” or “gm” for gram(s), “mL” for milliliters, and “rt” for room temperature, “nm” for nanometers, and like abbreviations).

Specific and preferred values disclosed for components, ingredients, additives, and like aspects, and ranges thereof, are for illustration only; they do not exclude other defined values or other values within defined ranges. The compositions, apparatus, and methods of the disclosure can include any value or any combination of the values, specific values, more specific values, and preferred values, including intermediate values and ranges, described herein.

The Corning, Inc., EPIC® technology is commercially available in several product platforms and can be used to perform label-free biological assays using resonance waveguide sensors in a microplate format. These assays can be performed, for example, on individual protein targets or cells using conventional high throughput screening (HTS) protocols. A resonant waveguide sensor is situated at the bottom of each well to detect refractive index changes at or near the surface of the sensor. The refractive index shift correlates to a mass change and can be used to detect binding of small molecules to the surface. The sensor can also detect changes in the mass distribution within cells within the evanescent wave, for example, of about 150 nm from the surface. This has been shown to correlate to certain cellular responses. The EPIC® reader system can be used to interrogate the microplate sensors and perform assays.

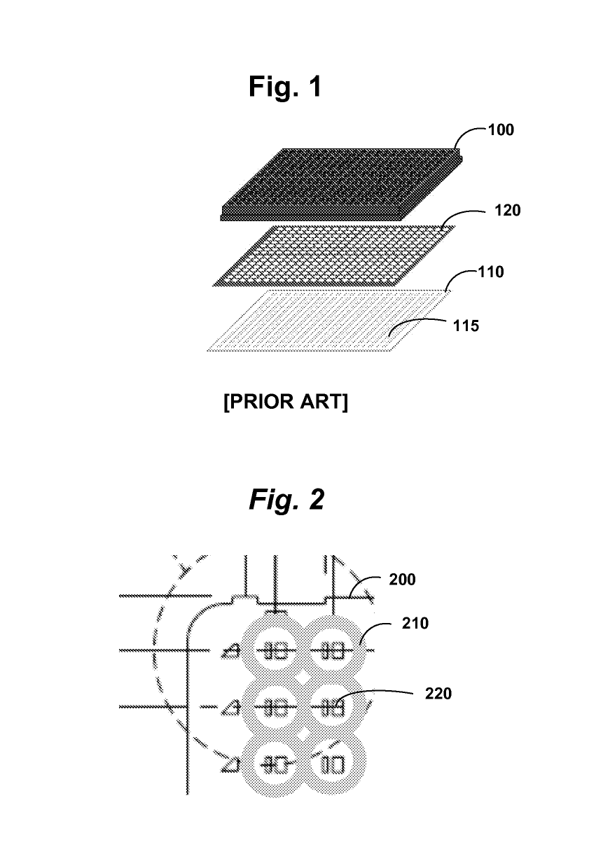

Existing resonant waveguide sensor fabrication methods are typically compatible only with planar substrates. For this reason, EPIC® microplate fabrication consists of attaching two separate components: a planar substrate (insert) having integral grating regions or resonant waveguide sensors, and a polymeric microplate body. The body material and the substrate can be separately injection molded with, for example, a cyclic olefin polymer (COP) or copolymer (COC). The surface of the sensor region can be coated with a high refractive index film, for example, a 50 to 200 nm niobium oxide (Nb₂O₅), or like oxides, mixed oxides, or mixtures thereof, to impart sensor functionality and form to the so-called “waveguide coating”. Referring to the figures, a prior art method for assembling microplates is shown in the exploded assembly of FIG. 1. The prior art method for making a microplate assembly includes a well plate (100), a substrate or insert (110) having one or more grating regions (115), and an intermediate double-sided adhesive gasket (120). The substrate can be attached to an injection molded microplate body using the adhesive gasket to form the assembled microplate. Alternative methods of assembling microplates are known and include, for example, the use of a liquid curable adhesive, or laser bonding.

In embodiments, the disclosure provides an alternative and lower cost method of assembling or producing microplates, which involves an over-molding methodology. Over-molding is a process that has been used for producing well plates where the insert and body are constructed of like materials. In this process, the insert or substrate can be loaded into the injection mold for the body, and the body is molded onto the substrate. The disclosed process combines two injection molding steps of the body with assembling the microplate into a single process. Because the substrate and materials are made of the same or similar material, the hot injected polymer melt heats the substrate (i.e., insert) and an adherent bond can be formed by polymer entanglement between the substrate and well plate materials.

For Epic® substrates having sensors, the niobium oxide film (i.e., waveguide coating) can prevent or inhibit contact between the surface or bulk resin of the substrate and the injected polymer melt, and hinder the formation of a hot melt adhesive or adherent bond. Experimental work has confirmed that bonding does not occur when an EPIC® well plate is over molded onto a substrate without application of the disclosed methods. Such inadequate or non-existent bonding can result in, for example, liquid leakage from the wells, liquid leakage can confound the assay results, a leaking well can contaminate adjacent wells and assay results, and like shortcomings.

Over-molding is a low cost method of producing microplates that call for a separate bottom substrate piece, such as the EPIC® microplate having RWG sensors present on or into the substrate surface, and the well plate portion of the microplate is formed in situ on the substrate residing in the over-mold cavity.

In embodiments, the disclosure provides one or more methods to overcome inadequate bonding between the over-molded body and the waveguide coated substrate arising from the material incompatibility of the intervening waveguide coating. The disclosed methods can include any or all of, for example:

surface roughening of the bonding area;

adding or creating micro-features or micro-textures to the bonding area; and

having collapsible features in the bonding area, and combinations thereof.

These methods can be readily integrated into the conventional microplate fabrication processes.

In embodiments, the disclosure provides a method of making an microplate, comprising:

injection molding a resin in a mold to form a substrate having at least one grating region feature on at least one surface of the substrate, and at least one micro-feature in the vicinity of the at least one grating region feature;

waveguide treating the resulting molded substrate; and

over-molding the resulting waveguide treated molded substrate with a compatible resin to from the integral well plate on the microplate.

The mold can include, for example, at least one relief feature corresponding to the at least one grating region feature, and the mold includes at least one relief feature corresponding to the at least one micro-feature. The at least one relief feature corresponding to the at least one grating region feature and the at least one relief feature corresponding to the at least one micro-feature each independently comprises a plurality of features. The at least one micro-feature can comprise, for example, a protrusion, an indentation, a column, a cylinder, or a combination thereof. The at least one micro-feature in the vicinity of the at least one grating region feature can be formed, for example, by a micro-feature relief stamp situated in the mold cavity. The at least one micro-feature in the vicinity of the at least one grating region feature can be formed, for example, by a micro-feature embossing stamp situated in a second mold cavity. The at least one micro-feature can collapse as a result of the contact with the hot melt resin injected into the mold. The vicinity of at least one micro-feature in the vicinity of the at least one grating feature comprises a portion of the latent bonding area between the sensor and the over-mold portion of the well plate.

The substrate and the over-molded well plate can comprise, for example, the same engineering polymer. The engineering polymer can be, for example, a COC or COP.

In embodiments, the disclosure provides a method of making an integral microplate, comprising:

surface roughening a portion of the latent bonding surface area of a preformed waveguide coated surface of a polymeric substrate having at least one integral grating region; and

over-molding the resulting surface roughened substrate and a compatible resin to form the integral microplate.

The surface roughening can be accomplished, for example, by at least one of laser ablation, electron discharge machining, mechanical abrasion, particle blasting, diamond turning, or a combination thereof.

The surface roughening can comprise, for example, a pattern comprising from 3 to about 10 concentric circles situated around at least one integral grating region. The surface roughening can comprise, for example, a pattern of 5 concentric circles situated around each integral grating region.

In embodiments, the disclosure provides methods for creating various or different surface features or structures on the substrate, with or without the waveguide coating present. The surface features or structures can be incorporated into the bonding area of the substrate and in the vicinity of the sensor grating region to enhance bonding between the substrate and the over-molded plastic well member. The features can include, for example, patterns or textures, such as distinct lines, random roughening, cross hatching, and like textures or patterns, or combinations thereof. All of these features can measurably improve the bonding between the over-molded body and the substrate. Although not limited by theory, it is believed that the bonding improvement may be the result of, for example: disruption of the conformal or contoured deposited waveguide layer to expose like underlying polymer resin, by mechanical interlock, or a combination of both. The formation of the features can be achieved by, for example, laser ablation, electron discharge machining, diamond turning, mechanical abrasion process, particle (e.g., sand) blasting, and like methods, or combinations thereof. Other methods for forming the features can be achieved by, for example, embossing, prior to or after waveguide over-coating of the grating region(s), and like methods, or combinations thereof. Although nearly all patterned features that were prepared exhibited improved bonding over an un-patterned or conventional oxide coated substrate, two methods were found to be particularly superior or exceptional.

In one method, a pattern of five (5) raised rings or concentric circles situated around the sensor region or surrounding the sensor region resulted in an effective mechanical interlock that provided excellent bonding between the over-molded body and the waveguide coated substrate that was sufficient for the finished part (i.e., microplate) to pass leak testing. The concentric circles pattern was produced using laser ablation methods on the molding master.

In a second method, a single high aspect ratio positive feature, for example, situated around the integral grating region or surrounding the integral grating region (i.e., sensor region), could be deformed during the over-molding flow with the injected plastic to produce a secure and leak-proof bond between the over-molded body and the waveguide coated substrate. The single positive feature was produced by machining a negative feature into the molding stamper using electron-discharge machining. The feature is a raised circular pattern in the bonding region with a height of 130 micrometers and a width of 100 micrometers. Other methods such as diamond milling, micro-routing, lithography, or dry etching could also be used to fabricate similar features. The aspect ratio of the feature and wall draft were believed to be significant to performance. An aspect ratio of greater than 1 (height/length) and wall draft of less than 10 degrees were found to be suitable.

The three general methods summarized below describe how the inventive methods and features can be incorporated, individually or collectively, into a substrate (a.k.a.: insert) bonding area.

### Method 1—Surface Roughening the Bonding Area

Surface roughness or surface roughening on the substrate surface, prior to the waveguide deposition process, can prevent formation of a conformal, contoured, or uniform coating of the waveguide layer (e.g., niobia oxide) during the waveguide deposition process. Referring again to the figures, the roughness can be deliberately placed in the regions where bonding to the over-mold microplate is desired, such as the thick circular lines (210) circumscribing the sensor regions (220) of the substrate (200) as illustrated in FIG. 2, which shows the bonding region(s) on a substrate in thick circular bands or lines (210) over six wells in a corner of a substrate.

During over-molding of these roughened substrates, the hot melt penetrates the crevices in the roughened areas and forms a mechanical bond by mechanical interlock or a hot melt adhesive bond by melting through the thinned waveguide layer.

The surface roughness can be incorporated into the substrate using different methods. Roughening of the substrate can be accomplished by, for example, laser ablation, mechanical, embossing, and like techniques, or combinations thereof. However, additional substrate processing steps can increase the cost and reduce the simplicity advantages of the disclosed over-molding process. Similarly, physical masking or ink blocking of the waveguide or their removal following waveguide deposition can add significant cost and complexity to the process.

Two methods for surface roughening that can be readily integrated into existing well plate manufacturing processes have been identified. One surface roughness or roughening method can be implemented using a roughened stamper during the injection molding of the substrate. The stamper can be, for example, a thin nickel electroform that contains nano-sized grating patterns. The electroformed stamper can be roughened in the bonding areas using various techniques mentioned herein. A second surface roughening method includes a two-step substrate molding process where a second cavity contains the roughness pattern. The molded substrate can be embossed by the roughened pattern. Both of these methods can be integrated with minimal impact on the variable cost or throughput, and without adding an additional step to the process.

### Method 2—Micro-Featuring or Micro-Texturing in the Bonding Area

Method 1 is similar to Method 2 with the exception that instead of imparting surface roughness to the substrate, the well-defined features or micro-texturing can be imparted onto the stamper to promote bonding due to mechanical interlocking. These well-defined features or micro-textures generally have greater surface area to provide improved or more robust bonding between the substrate and microplate body. A significant method used to define features or micro-textures in the nickel electroform is achieved by laser ablation.

### Method 3—Collapsible Features in the Bonding Area

Method 3 is similar to Method 2 with the exception that the feature size and feature density is significantly different. In Method 3, a single feature situated in the bonding region having a high aspect ratio can be induced to collapse during the melt injection molding, which collapse results in exposure of the bulk substrate material. In this instance, an adherent bond or hot melt adhesive bond can be formed by, for example, molecular entanglement with the same or similar polymer substrate material. This forms a much stronger bond than mechanical interlock. The collapsible feature approach is a significant method to achieve molecular entanglement type bonding.

The disclosed over-mold bonding processes are advantaged by, for example:

the process is significantly less complex and lower cost than use of separate adhesives and bodies because, for example, the elimination of a separate body molding step and a quality control (QC) step (e.g., leak testing);

the over-molded microplates cannot be contaminated by a joining adhesive or sealant since they are unnecessary and eliminated;

the over-molded microplates do not require an additional wettability treatment; and

the over-molding method is compatible with insert-based surface chemistry applications, i.e., providing a chemical surface treatment to the surface of the waveguide coated sensor region of the fully assembled well plate.

All of disclosed methods enable implementation of over-molding without additional cost and complexity of a separate insert processing step to remove the waveguide material in the bonding area.

In Method 1 (surface roughness) the roughness can be readily replicated in the electroforming processes (i.e., father, mother, son), whereas features having an aspect ratio greater than 1 cannot; and Method 1 requires less mold separation force than well-defined structures having aspect ratios greater than 1.

In Method 2 (micro-features or micro-texturing in the bonding area) structure features or textures can provide larger surface areas for bonding and that lead to higher bonding strength.

In Method 3 (collapsible features in the bonding area) provides polymer-polymer entanglement bonding, which forms an adherent or hot melt adhesive bond which is generally stronger and more leak resistant than a mechanical interlocking bond.

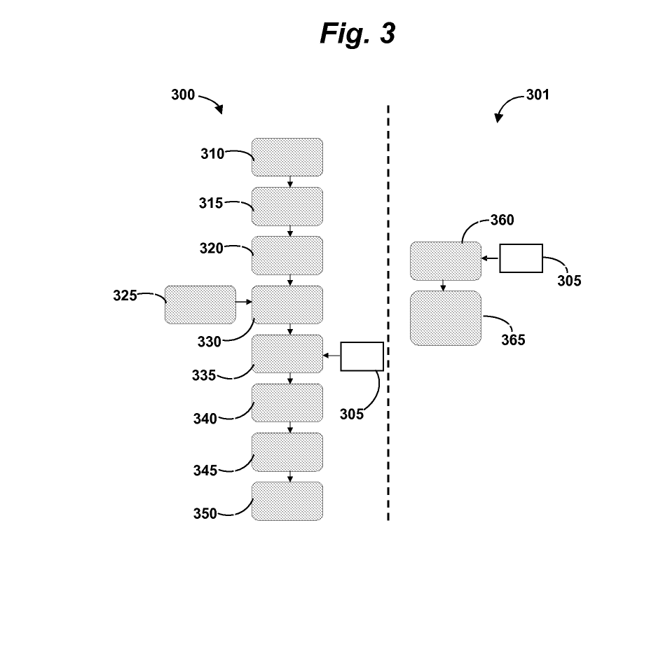

Referring again to the figures, FIG. 3 shows a comparative flow chart of the prior art pressure sensitive adhesive (PSA) process (300)(left side) shown in FIG. 1, and the disclosed over-molding process (301) (right side). In the PSA process (300) a well plate body is molded (315), quality control inspected, and then if selected, plasma treated (320) before qualifying (325) and applying (330) the PSA gasket to either the well plate body or the substrate (305). The combined assembly can then be vision inspected (335), tamped (340), seal inspected (345), and leak checked (350). In contrast, the disclosed over-mold process (301) combines the pre-formed substrate (305) or insert having grating regions in an over-mold to form the over-molded one-piece or integral microplate (360) product. The product can be quality inspected (365), if desired, for flatness and grating location fidelity.

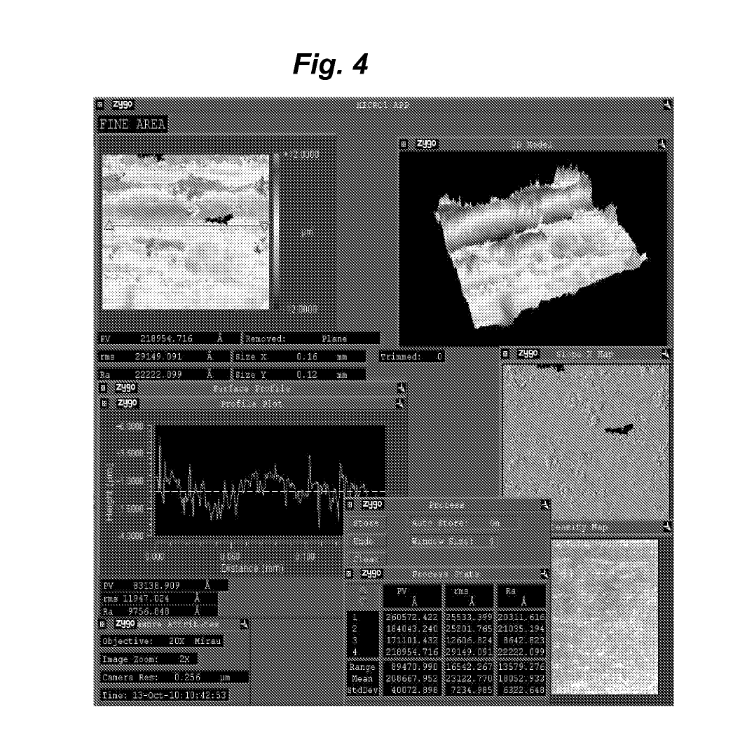

FIG. 4 shows typical RMS imagery and quantitative output from optical profilometry of a roughened substrate without a waveguide coating of the disclosure. This sample was roughened over its entire surface using 220 grit sand paper. The resulting surface RMS can be from 1.2 to 2.9 micrometers.

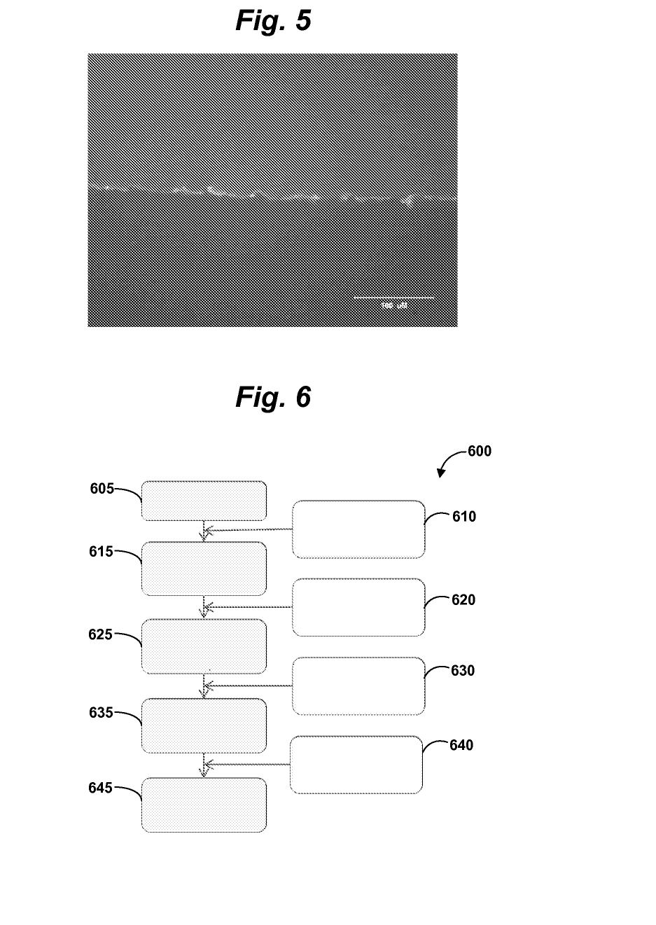

FIG. 5 shows an exemplary SEM cross-section of mechanically roughened substrate piece (bottom half) bonded to an over-molded well plate piece (top half) of the disclosure. The waveguide interface (middle) is substantially continuous, but is noticeably thinned out in some regions as a result of the roughening treatment.

FIG. 6 shows a flow chart of the substrate stamper replication process (600) and can include in series: master replication (605), UV replication (615), for example providing four replicas per master, stamper replication (625), for example providing twenty stampers per replica, insert molding (635), for example providing about one thousand substrates (1000s) per stamper, and over-molding (645), for example providing one over-molded microplate per insert. The disclosed surface roughening methods can be conveniently accomplished at one or more steps in the substrate molding process, such as roughening the stamp master (610), roughening the stamp replica (620), roughening the actual stamper (630), roughening the substrate or insert (640), or a combination thereof. Since the stamper replication process is a ‘pyramid,’ introduction of substrate surface roughening earlier rather than later can significantly, such as geometrically or exponentially, reduce product variability, reduce process complexity, reduce unit operations, and reduce overall costs.

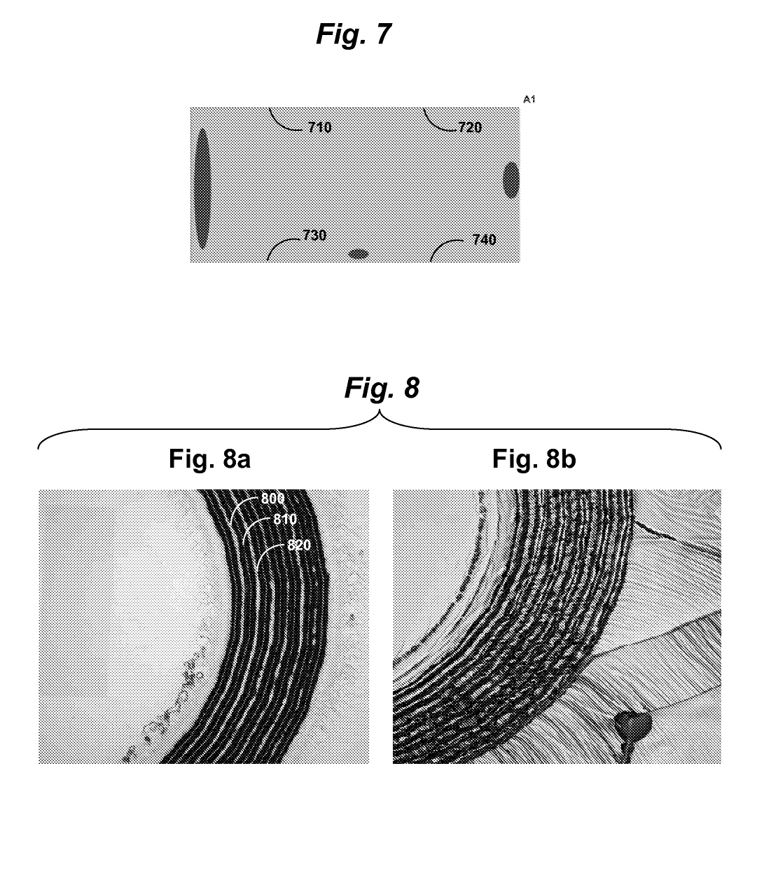

FIG. 7 schematically shows a representative microplate in plan view where the shaded ovals indicate areas where leaky well regions were typically or consistently obtained for microplates made during development of the inventive methods and screening of alternative methods. The most common regions of poor leak performance (leaky wells) are farthest from the four gate locations (710, 720, 730, and 740), presumably because of lower shear stress and temperature. A1 represents a well reference mark.

FIGS. 8A and 8B show, respectively, exemplary optical micrographs of before over-molded (left image) and after over-molded (right image) substrates of the laser formed five (5) raised ring pattern. The images indicate the presence of the waveguide (light shading; middle) coating material at the interface, although some feature collapse is also evident.

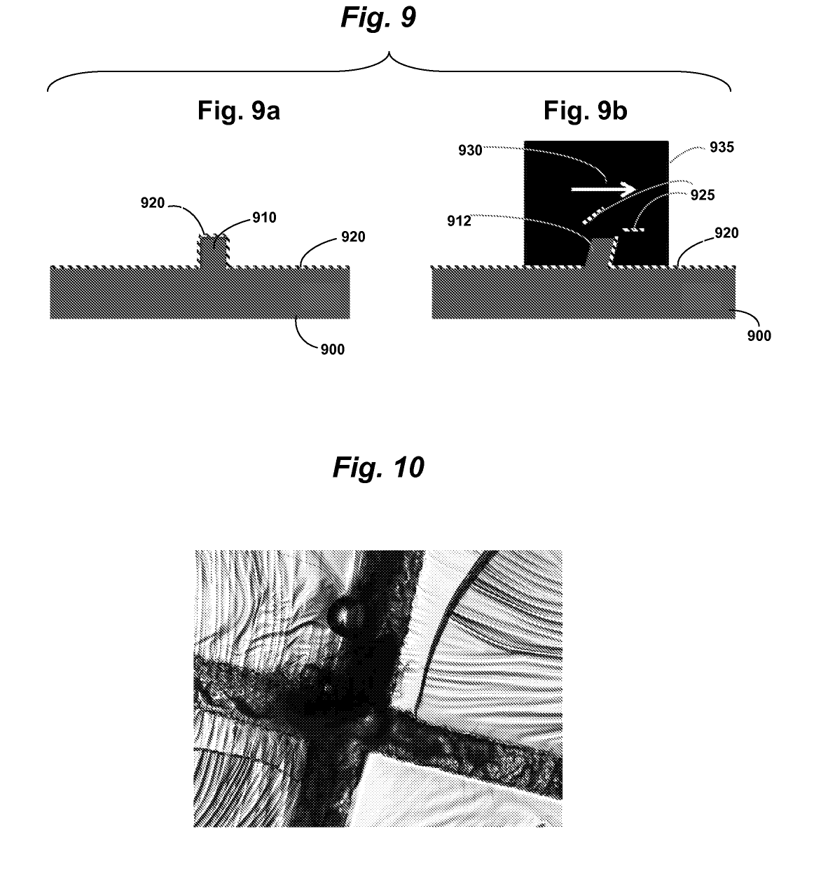

FIGS. 9A and 9B show, respectively, before and after molding schematics, and illustrate a hypothetical mechanism for the bonding expected in Method 3. Before molding (FIG. 9A), a substrate or insert (900) can have or be made to have a high aspect ratio feature (910) and can be, for example, 100 microns wide by 200 microns high. The waveguide coating thickness (920) can be, for example, from about 50 to 200 nanometers, such as 150 nm. During molding of the well plate body (935), the high aspect ratio feature (910) on the substrate or insert (900) can become distorted or deformed (912). In addition, shear heating and convective heat transfer from the injection molding resin flow (930) that produces deformation of the feature (rectangle; 9A left), can also ablate, fragment (925), or cause like degradation, of the waveguide surface coating (920) and expose the distorted feature(s) (trapezoid; 9B right) (912) comprised of underlying plastic material (900). A bond between the substrate (900) and well plate pieces (935) can be formed by molecular entanglement of like polymers.

FIG. 10 shows an optical micrograph of a substrate having features that were over-molded using Method 3. The dark shading in the feature indicates adherent bonding. The feature is approximately 100 microns wide.

### EXAMPLE(S)

The following examples serve to more fully describe the manner of using the above-described disclosure, and to further set forth best modes contemplated for carrying out various aspects of the disclosure. These examples do not limit the scope of this disclosure, but rather are presented for illustrative purposes. The working example(s) further describe(s) how to prepare the substrate-sensor grating articles and microplate articles incorporating the substrate-sensor grating articles of the disclosure.

### Materials and Methods

Injection Molding

Injection molding of both inserts and over-molded bodies can be performed using a commercially available engineering resin, for example, a cyclic co-olefin material (e.g., Topas 5013L). The microplate over-mold is of typical design having a core and cavity half. Substrates (i.e., inserts) can be molded using, for example, a side-gate or fan-gate style substrate mold using the same polymer as the well plate portion. The grating pattern can be transferred to the substrate using a stamper that is placed in one of the halves of the substrate mold. The stamper can be, for example, a 300 micrometer nickel plate fabricated, for example, by electroforming over a polymer master that contains the grating pattern. This stamper technology is comparable to DVD fabrication processes. Substrates can optionally be coated with a niobia waveguide layer, or like surface treatment following injection molding.

### Microplate Characterization Methods

Leak testing of microplates can be performed using, for example, a centrifugation protocol. Microplates can be filled, for example, with colored water in every other well (50 microL/well) forming a checkerboard pattern. Microplates can be, for example, centrifuged at 1,000 then 2,000 rpm for 1 minute and 10 minutes, respectively, at typical accelerations. Leaking wells can be identified, for example, by visual inspection following each centrifugation step. Sensor damage can be evaluated, for example, by 2D resonance maps using the Corning, Inc., EPIC® label free platform technology.

High resolution microplate maps of the entire sensor can be performed using the EPIC® high throughput screening (HTS) reader. The resolution can be, for example, 12 micrometers in the scanning direction and 100 micrometers in the orthogonal direction. Microplate flatness can be measured at each well using, for example, a laser displacement probe.

### Stampers

Stampers can be 300 micrometers thick and made of high-sulfur nickel. Stampers can be fabricated and obtained from, for example: Temicon Gmbh.

### Laser Processing

Laser processing was performed by, for example, Photomachining, Inc., using a low (Matrix) and high power (Pulseo) pulsed lasers. The Matrix laser is a 2 W diode pumped solid state with output at 355 nm. The Pulseo laser is a 10 W Master Oscillator Power Amplifier laser with output at 355 nm. The typical line-width and depth range of Matrix laser was 12 to 17 micrometers wide and 8 to 30 micrometers deep depending on the parameters. The typical range of the 20 W Pulseo laser was 50 micrometers wide and 10 to 75 micrometers deep depending on the conditions.

### Roughness Measurement

Roughness and surface characterization was determined by non-contact optical profilometry.

### Results and Discussion

Microplate Requirements

The two significant EPIC® microplate failure modes that could be significantly enhanced by implementation of the disclosed methods is cross-talk or leaking between wells, and sensor damage. The disclosed methods result in bonding between the body and the insert needed to form wells above the sensor. Each well must seal completely to prevent cross-contamination between wells during use in an assay. During screening, each well typically contains a unique compound, biological, a cell, or cell derivative. Any leaking would invalidate measurements made on the microplate. Lack of sensor damage can be evaluated by high resolution sensor maps using the EPIC® technology. It is also significant that the disclosed process can concurrently seal wells and does not impact other microplate requirements, for example, overall flatness, within-well flatness, delamination resistance, and sensor performance. All of these metrics can be measured or verified following demonstration of well seal integrity.

### Method 1: Surface Roughness in Bonding Region for Enhanced Adhesion

Experimentation confirmed that roughening an insert (i.e., substrate) in the bonding region prior to waveguide coating promotes well member bonding with the over-molding process. This method was initially demonstrated by physically roughening an entire insert surface using either 80 or 220 grit sandpaper. The roughened inserts were waveguide coated and over-molded. Inserts roughened with either 80 or 220 grit sandpaper passed centrifugation testing and indicated that roughening was a reliable method. The roughening was characterized by non-contact profilometry as shown in FIG. 4. A benchmark RMS roughness of 1.2 to 2.9 microns was determined.

Characterization indicated that the bonding is primarily mechanical in nature. Although the completed microplate passes centrifuge testing, the insert can be forcibly (i.e., destructively) removed from the microplate with minimal breakage. Furthermore, SEM images indicate the continuous presence of the waveguide interface as shown in FIG. 5.

Although it may be possible to roughen individual inserts prior to the waveguide patterning step, an additional process step increases complexity and manufacturing costs even if integrated. Indeed, any insert-based roughening would require precise alignment with the grating sensors, adding further cost and eroding the benefits of over-molding. Any process may also be inherently variable and may require quality control measures. Furthermore, a more straightforward process would likely entail removal of the waveguide layer following the deposition process or blocking of the waveguide deposition instead of features adapted to disrupt it. The principle advantage of the surface roughening feature is that is can be incorporated into the insert stamper and replicated into each injection molded insert. The roughening pattern could eventually be incorporated into the primary glass master and replicated into each UV replica and stamper electroform, requiring the roughening process to be accomplished only once. This reduces costs and process variability. This effect is illustrated in comparative flow charts of FIG. 6.

A number of methods to demonstrate roughening the stamper have been evaluated including, for example, electron discharge machining (EDM) and mechanical methods. Electron discharge machining was used to impart a controlled surface roughness into the bonding area. The most aggressive pattern that did not cause backside damage was targeted. Secondly, a number of mechanical methods were used to abrade the stamper surface. This included use of a sand paper (80 grit) and manual diamond scribing with various 1D and 2D patterns. For all of the methods, the RMS roughness ranged from 0.5 to 3.5 microns. All methods gave similar performance for pattern replication from the stamper to the insert. All roughening methods resulted in some leaking wells which tended to be located in consistent leak regions (ovals) illustrated in FIG. 7, although this represents a significant improvement over well seal performance with inserts that were not roughened. The leaky areas are farthest from the injection gates and are the ‘last to fill’ where the melt shear is typically the lowest. In general, this is the area that is most difficult to achieve reliably well bonding. It is expected that the disclosed over-mold process can be further modified to improve bonding in these regions although the over-mold process can also be further improved for other significant specifications including in-well flatness, global flatness, waveguide delamination, and minimization of sink features. A summary of the comparison of different methods used to roughen the stamper are listed in Table 1. The surface roughness of the resulting inserts was measured using optical profilometry.

TABLE 1
Comparison of methods used to roughen the stamper.

| | | Insert surface |
|---|---|---|
| Method and | | roughness range |
| Equipment | Description | (RMS, microns) |
| 220 grit | Manual application to | 1.2 to 2.9 |
| sandpaper | insert | |
| 80 grit | Manual application to | 2.2 to 4.6 |
| sandpaper | insert | |
| Electron | Target Charmilles 24 | 1.6 to 1.8 |
| discharge | on stamper | |
| machining (EDM) | | |
| EDM | Target Charmilles 28 | 1.9 to 2.3 |
| | on stamper | |
| EDM | Target Charmilles 32 | 1.2 to 4.1 |
| | on stamper | |

Another suitable method to impart roughness can be, for example, focused sand blasting using a small aerosol jet such as the commercial Optomec Aerosol Jet system. Conventional sand blasting can be used in conjunction with masking the stamper in non-bonding regions. This can be accomplished by applying a blanket adhesive tape (such as Nitto tape), laser cutting a pattern, and removing the tape from the bonding areas. Still another method of imparting surface roughness or other features can be, for example, accomplished using a 2-shot mold during insert injection molding. This can be implemented by pressing a hot plate with the roughening pattern into the insert following the initial molding cycle.

One of the primary advantages of the disclosed surface roughening over other stamper patterning methods is the insert replication robustness. The reduced surface area and feature depth improve the ease that which the insert releases from the stamper during the molding cycle. Another advantage is that the roughness can likely be replicated during the electroforming process, enabling roughening of a first generation stamper. The features would be replicated into the second and third generation stampers. High aspect ratio features, such as those described in Method 2 cannot be readily achieved by replication. These features, however, can be implemented into the substrate by other means. Generally electroforming cannot be performed reliably on features with an aspect ratio larger than 1.

### Method 2: Micro Features or Micro-Texturing in Bonding Region for Adhesion

This method is similar to Method 1 where the bond can be formed by mechanical interlocking. Here micro-features can be formed by laser ablation, melting, or a combination thereof, of the nickel stamper. Features may include, for example, one or more concentric circles around each grating. In embodiments, micro-texturing was accomplished by a laser processing with a cross-hatch pattern of various pitches ranging from 20 to 100 microns. More complex texture patterns were accomplished by overlying a second pattern with an origin offset or a 45 degree angular offset.

For many of the patterns made in Method 2, the bonding results were similar to the results for Method 1. The pattern on the molded insert was accurately reproduced during the insert molding process as indicated by visual inspection and dimensional measurements. Release of the molded substrate from the stamper varied depending on the draft angle and depth of the pattern of the features. The bonds formed were believed to be mechanical in nature and the substrate and over-molded well plate could be forcibly separated. Leaking wells were also identified in characteristic regions such as illustrated in FIG. 7. One single pattern, however, produced microplates having 100% leak-free wells during centrifugation testing. This leak-free pattern was a set of five (5) concentric circles spaced at 100 micron intervals formed using the Pulseo laser. The setup of the laser was: 100% power, 30 KhZ, 15 mm/s table speed, and 200 passes. The approximate dimensions of the features were about 75 microns wide by 10 to 20 microns deep. The bonding mechanism was determined to be mechanical interlock consistent with performance results of Method 1 as indicated by the ability to clean separate the pieces forcibly. Optical inspection following separation also suggested a mechanical interlock. Optical micrographs of the substrate features before (left image) and after (right image) over-molding are shown in FIG. 8. From the images it is apparent that a significant amount of the waveguide layer was still present as indicated by the ‘wrinkled’ film in between the rings. In destructive testing, the molded parts separated with a force indicative of a mechanical interlock bonding mechanism. Inspection of 2D EPIC® resonance maps of the substrates obtained by the laser patterning method indicated no damage to the grating structure. A visual and optical inspection revealed some laser burn marks, but these were isolated to within 50 microns of the bonding region pattern.

Many of the other micro-texture methods significantly improved bonding between the insert during over-molding. With further process and pattern development, most if not all micro-texture patterns can provide over-molded seals having 100% leak-free performance.

### Method 3: Collapsible Features

The third method for bonding a waveguide coated substrate or insert to the over-molded body includes a collapsible feature, for example, of specific dimensions. It was found that a single high aspect ratio feature located in the bonding region can provide a strong bond between the insert and the well plate member if the feature is properly designed. During injection of the melt, the surface of the insert experiences high temperatures due to the thermal mass of the melt, but also due to the shear stress imparted by the high velocity of melt flowing over the surface. This is termed ‘shear heating’. As illustrated in FIG. 9, the mass of high aspect ratio feature is much smaller than the mass of the melt surrounding the feature. This results in a condition where rapid heating occurs due to the ratio of surface area to mass of the feature. The rapid heating causes the plastic core of the feature to melt and the waveguide coating to be swept away by the melt. The plastic-to-plastic contact enables polymer entanglement forming a bond similar to conventional over-molding where the inserts are not waveguide coated.

Fabrication of such a high aspect ratio feature is not trivial. Trenches were fabricated on the nickel stamper to produce positive features on the insert. The trenches were fabricated using electron discharge machining resulting in a trench of 100 microns wide and 200 microns deep into the nickel stamper. The trench was made by repeated plunges every 50 to 75 microns using a 100 micron diameter wire. It is expected that a trench of acceptable dimensions can be made using other methods including laser or diamond turning. Previous laser experimentation, however, suggested that producing features of this depth and aspect ratio can be challenging.

A stamper has been processed to demonstrate the concept. Six trenches (3 orthogonal to each other) were made in the stamper. Acceptable replication of the feature was observed during substrates molding. Following waveguide coating and over-molding of experimental substrates (inserts), it was found that substrate-to-well plate bonding occurred at the feature locations. The nature of the bonding was determined by optical inspection upon separation of the insert from the over-molded body. An optical micrograph of the feature is shown in FIG. 10.

The disclosure has been described with reference to various specific embodiments and techniques. However, it should be understood that many variations and modifications are possible while remaining within the scope of the disclosure.

1. A method of making a microplate, comprising:
injection molding a resin in a mold to form a substrate having at least one grating region feature on at least one surface of the substrate, and at least one micro-feature in the vicinity of the at least one grating region feature;
waveguide treating the resulting molded substrate; and
over-molding the resulting waveguide treated molded substrate with a compatible resin to from the integral well plate on the microplate.

2. The method of claim 1 wherein the mold includes at least one relief feature corresponding to the at least one grating region feature, and the mold includes at least one relief feature corresponding to the at least one micro-feature.

3. The method of claim 2 wherein the at least one relief feature corresponding to the at least one grating region feature and the at least one relief feature corresponding to the at least one micro-feature each independently comprises a plurality of features.

4. The method of claim 1 wherein the at least one micro-feature comprises a protrusion, an indentation, a column, a cylinder, or a combination thereof.

5. The method of claim 1 wherein the at least one micro-feature in the vicinity of the at least one grating region feature is formed by a micro-feature relief stamp situated in the mold cavity.

6. The method of claim 1 wherein the at least one micro-feature in the vicinity of the at least one grating region feature is formed by a micro-feature embossing stamp situated in a second mold cavity.

7. The method of claim 1 wherein the at least one micro-feature collapses as a result of the contact with the resin injected into the mold.

8. The method of claim 1 wherein the vicinity of at least one micro-feature in the vicinity of the at least one grating feature comprises a portion of the latent bonding area between the sensor and the over-mold portion of the well plate.

9. The method of claim 1 wherein the substrate and the over-molded well plate comprise the same engineering polymer.

10. The method of claim 9 wherein the engineering polymer is COC.

11. A method of making an integral microplate, comprising:
surface roughening a portion of the latent bonding surface area of a preformed waveguide coated surface of a polymeric substrate having at least one integral grating region; and
over-molding the resulting surface roughened substrate and a compatible resin to form the integral microplate.

12. The method of claim 11 wherein the surface roughening is accomplished by at least one of laser ablation, electron discharge machining, mechanical abrasion, particle blasting, diamond turning, or a combination thereof.

13. The method of claim 11 wherein the surface roughening comprises a pattern comprising from 3 to about 10 concentric circles situated around at least one integral grating region.

14. The method of claim 11 wherein the surface roughening comprises a pattern of 5 concentric circles situated around each integral grating region.
